(19) United States
(12) Patent Application Publication
(10) Pub. No.: US 2019/0274261 A1
(43) Pub. Date: Sep. 12, 2019

(54) Product Holder For A Rotating Cultivation Of Crops

(71) Applicant: Logiqs B.V., Maadijk (NL)

(72) Inventor: Gerrit Johannes Van Staalduinen, Maasdijk (NL)

(73) Assignee: Logiqs B.V.

(21) Appl. No.: 16/347,477

(22) PCT Filed: Nov. 15, 2017
(86) PCT No.: PCT/NL2017/050741

§ 371 Date: May 3, 2019

(30) Foreign Application Priority Data
Nov. 15, 2016 (NL) 2017787

(51) Int. Cl. A01G 9/02

(52) U.S. Cl. CPC A01G 9/02

(57) ABSTRACT

Product holder for a rotating cultivation of crops including potted plants, which holder is provided with:
a platform that is executed predominantly flat for supporting the crops,
running wheels and/or guide wheels that are attached to the bottom side of the platform for allowing the holder to be rotated through a greenhouse in a manner that may or may not be automated,
wherein the platform has a largest dimension in a longitudinal direction that is oriented transverse to the driving direction of the wheels and, considered in the driving direction, is bounded by a longitudinal side, wherein the platform comprises self-supporting, rigidity enhancing means extending in the longitudinal direction for providing sturdiness and flatness to the platform and the entire holder,
wherein an impact absorbing means extends from the rigidity enhancing means for absorbing force resulting from the impact the product holder is subjected to when the impact absorbing means hits an obstacle.

The invention relates to a product holder for a rotating cultivation of crops, including potted plants, which holder is provided with:
a platform that is executed predominantly flat for supporting the crops,
running wheels and/or guide wheels that are attached to the bottom side of the platform for allowing the holder to be rotated through a greenhouse in a manner that may or may not be automated,

wherein the platform has a largest dimension in a longitudinal direction that is oriented transverse to the driving direction of the wheels and, considered in the driving direction, is bounded by a longitudinal side, wherein the platform comprises self-supporting, rigidity enhancing means extending in the longitudinal direction for providing sturdiness and flatness to the platform and the entire holder.

Such a device is generally known in the field.

Such devices are constructed sturdy and robust as such product carriers are used in a rough environment, wherein the product carriers are for instance pushed against each other when several abutting product carriers have been placed in a row that needs to be pushed onwards as a whole.

A drawback of such product carriers is that the construction is provided with parts allowing the rough use of the product carriers, resulting in the product carrier being a heavy part that is expensive to manufacture and expensive to use, because for rotating the product carrier through the greenhouse, the driving means are geared to driving heavy product carriers.

It is an object of the invention to provide a product carrier that is at least less heavy but which, while retaining the function within the rotating cultivation of crops, can be used in the rough environment without the product carrier collapsing or causing failures.

According to a first aspect of the invention the product holder for a rotating cultivation of crops, including potted plants, is provided with:
a platform that is executed predominantly flat for supporting the crops,
running wheels and/or guide wheels that are attached to the bottom side of the platform for allowing the holder to be rotated through a greenhouse in a manner that may or may not be automated,

wherein the platform has a largest dimension in a longitudinal direction that is oriented transverse to the driving direction of the wheels and, considered in the driving direction, is bounded by a longitudinal side, wherein the platform comprises self-supporting, rigidity enhancing means extending in the longitudinal direction for providing sturdiness and flatness to the platform and the entire holder,

wherein an impact absorbing means extends from the rigidity enhancing means for absorbing force resulting from the impact the product holder is subjected to when the impact absorbing means hits an obstacle that is oriented in the driving direction. In that way it becomes possible to construct a lightweight product holder that at the same time is capable of absorbing the force exerted on the frame during hitting, or bumping against or merely touching an obstacle to which the product holder is moved during operation. During bumping the force, preferably in the longitudinal direction of the impact absorbing means, is led to the rigidity enhancing means extending in the longitudinal direction, wherein the force is thus distributed over the entire platform.

In one embodiment, the impact absorbing means extends to such an extent that, if the impact absorbing means hits the obstacle, an obstacle facing longitudinal side of the platform is substantially exempt from absorbing the force. In that way absorbing the force via the edge of the platform becomes superfluous, as a result of which the said edge can be constructed highly lightweight resulting in the overall product holder also becoming more lightweight and as a consequence having an economic advantage both in manufacturing and in use.

In one embodiment the obstacle facing side of the platform extends to such an extent that, if the impact absorbing means hits the obstacle, an obstacle facing edge of the platform almost touches the obstacle. In that way it become possible to have the edge of the platform extend just against the obstacle, as a result of which the surface provided for placing the cultivation can be used to the maximum.

In one embodiment, the obstacle facing longitudinal side of the platform is flexible. In that way it becomes possible to have the edge of the platform extend pressed against the obstacle, as a result of which the surface provided for placing the cultivation can be used to the maximum, but wherein the obstacle facing longitudinal side is configured to move along in a slightly springy manner in a direction that is opposite the driving direction, without the obstacle facing longitudinal side absorbing force resulting from the impact to a significant extent.

In one embodiment, the obstacle facing side of the platform is made of a polymer, such polyethylene, of any other flexible polymer material, such as a thermoplastic material, synthetic material, or rubber. In that way it becomes possible to provide the obstacle facing longitudinal side with flexible properties, as a result of which it is prevented that the obstacle facing longitudinal side absorbs force resulting from the impact to a significant extent.

In one embodiment, the impact absorbing means comprises a buffer element having such dimensions that a part of the obstacle hit by the impact absorbing means at least partially overlaps the buffer element. In that way it become possible to make the surface with which the impact is absorbed so large as to prevent the impact absorbing means from inserting wide of a further impact absorbing means of the obstacle, as a result of which the product holder and the obstacle in the form of a further product holder are inadvertently pushed into each other and remain hooked into each other, thus halting the rotating cultivation.

In one embodiment the buffer element is plate-shaped. In that way it becomes possible to equip the impact absorbing means with a sufficiently large contact surface, thus preventing the construction from becoming needlessly heavy.

In one embodiment, the impact absorbing means extends along a line of action of the force resulting from the impact that the product holder is subjected to if the impact absorbing means hits the obstacle. In that way it becomes possible to execute the impact absorbing means using short constructional components that are capable of leading the force to the rigidity enhancing means via the shortest way, wherein the weight of the product holder can be further saved on.

In one embodiment, the impact absorbing means, considered in the driving direction, has a front end configured for contacting a leading product holder, and considered in the driving direction, a rear end configured for being contacted by an approaching product holder, and wherein considered in the driving direction, the obstacle is a last product holder in a leading position relative to a trailing product holder, wherein the impact absorbing means of the leading product holder extends rearwards to such an extent that, if the impact absorbing means of the leading product holder receives the product holder, a further longitudinal side of the platform of the leading product holder, which longitudinal side faces the product holder, is substantially exempt from absorbing the force. In that way a product holder becomes possible which can be used in a logistic system of several product holders, wherein the product holders have substantially the same function and have substantially the same shape and dimensions, wherein the product holders that are positioned adjacent to each other, cooperate together and such that when the one product holder knocks against, bumps into or touches the other product holder, the impact absorbing means of the one product holder knocks against, bumps into or touches the impact absorbing means of the other product holder.

In one embodiment, the front end of the impact absorbing means is situated at a first distance from the rigidity enhancing means, wherein an obstacle facing edge of an obstacle facing longitudinal side of the platform is situated at a second distance from the rigidity enhancing means, and wherein the first distance is substantially equal to the second distance. In that way it becomes possible to provide a compact product holder of which both an end of the impact absorbing means, and the longitudinal edge of the platform are in one substantially vertical plane, such that they extend just against the obstacle if knocking, bumping or touching parts of said obstacle are also in one substantially vertical plane.

In one embodiment, the front end of the impact absorbing means is situated at a first distance from the rigidity enhancing means, wherein an obstacle facing edge of an obstacle facing longitudinal side of the platform is situated at a second distance from the rigidity enhancing means, wherein the rear end of the impact absorbing means is situated at a third distance from the rigidity enhancing means, and wherein an approaching product carrier facing edge of an approaching product carrier facing longitudinal side of the platform is situated at a fourth distance from the rigidity enhancing means, and wherein a sum of the first and the third distances is substantially equal to a sum of the second and fourth distances. In that way it becomes possible to provide a product holder of which an end of the impact absorbing means relative to the longitudinal edge of the platform are staggered relative to a substantially vertical plane.

In one embodiment, the first distance is smaller than the second distance and the third distance exceeds the fourth distance. In that way an alternative becomes possible wherein the platform of the product holder can extend above a part of the obstacle, for instance when the obstacle is a leading product carrier, wherein the platform of the product carrier, if the platform of the leading product carrier is adapted for receiving the product carrier, can extend above the impact absorbing means of a leading product carrier.

In one embodiment, the first distance exceeds the second distance and the third distance is smaller than the fourth distance. In that way an alternative becomes possible wherein the impact absorbing means can extend below a part of the obstacle, for instance when the obstacle is a leading product carrier, wherein the impact absorbing means of the product carrier, if the impact absorbing means of the leading product carrier is adapted for receiving the product carrier, can extend below the platform of a leading product carrier.

According to a second aspect of the invention, a method is provided for rotating cultivation of crops, including potted plants, using a product holder that is provided with:
a platform that is executed predominantly flat for supporting the crops,
running wheels and/or guide wheels that are attached to the bottom side of the platform for enabling the holder to be rotated through a greenhouse in a manner that may or may not be automated,

wherein the platform has a largest dimension in a longitudinal direction that is oriented transverse to the driving direction of the wheels, wherein the platform, considered in the driving direction, is bounded by a longitudinal side, and wherein the platform comprises self-supporting, rigidity enhancing means extending in the longitudinal direction for providing sturdiness and flatness to the platform and the entire holder,

wherein an impact absorbing means extends from the rigidity enhancing means for at least almost fully absorbing force resulting from the impact the product holder is subjected to when the impact absorbing means hits an obstacle,

wherein the product holder is moved in the driving direction against the obstacle, wherein the obstacle, considered in the driving direction, is a last product holder in a leading position relative to a trailing product holder. In that way rotating cultivation of crops, including potted plants, becomes possible with lightweight product holders that at the same time are capable of absorbing forces exerted on the frame during knocking against, bumping into or merely touching an obstacle to which the product holder is moved during operation. During bumping the force, preferably in the longitudinal direction of the impact absorbing means, is led to the rigidity enhancing means extending in the longitudinal direction, wherein the force is thus distributed over the entire platform. In that way absorbing a force via the edge of the platform become superfluous, as a result of which the said edge can be constructed highly lightweight resulting in the overall product holder also becoming more lightweight and as a consequence having an economic advantage both in manufacturing and in use.

In one embodiment a further product holder is moved in the driving direction against the product holder, wherein the further product holder, considered opposite the driving direction, is a first product holder following the product holder. In that way a logistic system becomes possible wherein several product holders that have substantially the same function and have substantially the same shape and dimensions, cooperate together and such that when the one product holder knocks against, bumps into or touches the other product holder, the impact absorbing means of the one product holder knocks against, bumps into or touches the impact absorbing means of the other product holder.

The invention will now be described in more detail on the basis of a number of embodiments with reference to the figures, in which:

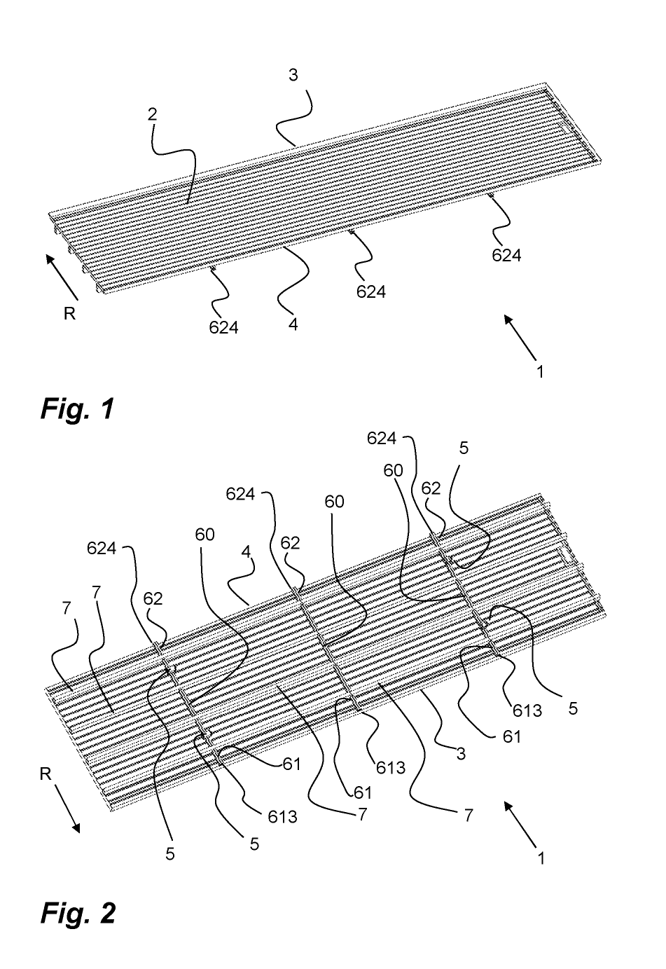

FIG. 1 shows a top view in perspective of a product carrier according to a preferred embodiment of the invention;

FIG. 2 shows a bottom view in perspective of the product carrier according to FIG. 1;

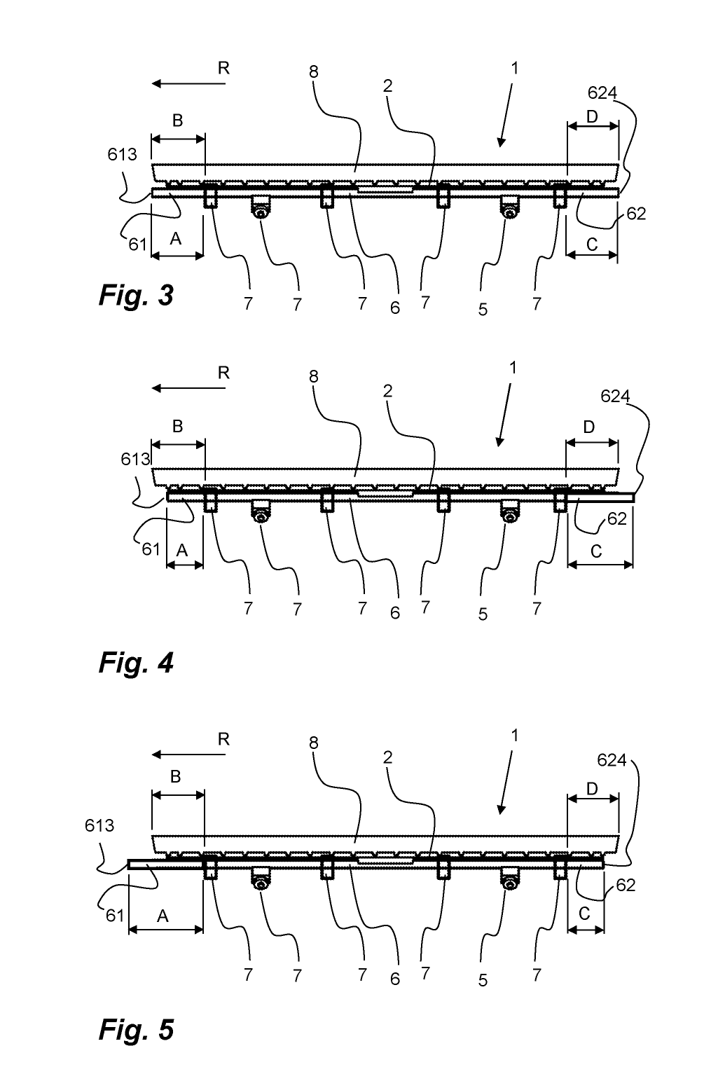

FIGS. 3, 4 and 5 show side views of respective embodiments of the product carrier according to FIG. 1 or 2, wherein the view extends parallel to the driving direction of the product carrier.

In all figures identical reference numbers indicate identical parts. FIG. 1 shows a top view in perspective of a platform 2 of a product holder 1 for a rotating cultivation of crops, including potted plants. The product holder 1 is provided with a platform 2 that is executed predominantly flat for supporting the crops.

The product holder 1 is usually made of metal or of a steel type which prior to use cultivation in a greenhouse, has been exposed to a surface treatment, such as galvanisation or thermal galvanisation or covering the surface with a coating.

The product holder 1 is intended for supporting a tray 8, which for instance has been made of expanded polystyrene (EPS) or an alternative synthetic material. In another embodiment, the tray has been made of a steel plate or in view of weight reduction, of a gauze mat or a lattice work in which crates fit that are intended for the cultivation of for instance tulips.

FIG. 2 shows a bottom view in perspective of the product carrier 1. Against the bottom side of the platform 2 running wheels and/or guide wheels 5 have been attached for being able to rotate the product holder 1 through a greenhouse in a manner that may or may not be automated, wherein the wheels can be moved over tracks or guides that are not shown. The platform 2 has a largest dimension in a longitudinal direction that is oriented transverse to the driving direction R of the wheels 5. Considered in the driving direction R, the platform 2 is bounded by a longitudinal side 3, 4, wherein the platform 2 comprises a self-supporting rigidity enhancing means 7 extending in the longitudinal direction, for providing sturdiness and flatness to the platform 2 and the entire holder. According to the invention an impact absorbing means 61, 62 extends from the rigidity enhancing means 7 for absorbing force resulting from the impact the product holder 1 is subjected to when the impact absorbing means 61, 62 hits an obstacle that is oriented in the driving direction R.

According to the invention, the impact absorbing means 61, 62 extends to such an extent that, if the impact absorbing means 61, 62 hits the obstacle, an obstacle facing longitudinal side 3, 4 of the platform 2 is substantially exempt from absorbing the force.

In one embodiment the obstacle facing side of the platform 2 extends to such an extent that, if the impact absorbing means 61, 62 hits the obstacle, an obstacle facing edge 3 of the platform 2 almost touches the obstacle. It is prevented then that the obstacle facing edge 3 of the platform 2 absorbs the impact, so that the edge 3 can be constructed lightweight. By optionally constructing the obstacle facing longitudinal side 3 of the platform 2 flexible, the edge 3 can extend up to the vertical plane in which, considered in the driving direction R, a front end 613 of the obstacle facing impact absorbing means 61 extends. For that purpose, the edge can be made of any flexible polymer material, such as a thermoplastic material, synthetic material, or rubber.

The front end 613 of the impact absorbing means 61, 62 is provided with a buffer element having such dimensions that a part of the obstacle hit by the impact absorbing means 61, 62 at least partially overlaps the buffer element. In that way the buffer element can be executed plate-shaped, wherein the plate has a surface that is so large that the part of the obstacle which the impact absorbing means 61, 62 hits, cannot be missed.

The impact absorbing means 61, 62 extends along a line of action of the force resulting from the impact that the product holder 1 is subjected to if the impact absorbing means 61, 62 hits the obstacle. The impact absorbing means 61, 62 extends substantially transverse to the rigidity enhancing means 7 so that the force resulting from the impact, can be distributed in the longitudinal direction of the rigidity enhancing means 7. As shown in FIG. 2, the impact absorbing means 61, 62 can be linked to one to the other by means of a linkage of constructional elements 60, so that the force resulting from the impact can be distributed in the longitudinal direction over several rigidity enhancing means 7.

The front end 613 is configured for touching a leading product holder 1, and absorbing a hit that way, when the product holder 1 is pushed against an obstacle. The obstacle can then be formed by a last product holder 1 in a leading position relative to a trailing product holder 1.

The product holder 1 is furthermore provided with, considered relative to the driving direction R, a rear end 624. The rear end 624 is configured for being hit by an approaching product holder 1, and absorbing a hit that way, when the approaching product holder 1 is pushed against the product holder 1.

The impact absorbing means 62 of the leading product holder 1 extends rearward to such an extent that, if the impact absorbing means 62 of the leading product holder 1 receives the product holder 1, a further longitudinal side 4 of the platform 2 of the leading product holder 1, which longitudinal side faces the product holder 1, is substantially exempt from absorbing the force.

FIG. 3 shows a side view of a compact product holder 1 according to the invention, wherein the longitudinal sides 3, 4 of the platform 2, and the front end 613 and the rear end 624 of the impact absorbing means 61, 62 extend up to the sides of a circumscribed rectangle.

In this example the front end 613 of the impact absorbing means 61 is situated at a first distance A from the rigidity enhancing means 7, and an obstacle facing edge 3 of an obstacle facing longitudinal side 3 of the platform 2 is situated at a second distance B from the rigidity enhancing means 7. In the example of the compact product carrier 1 according to FIG. 3, the first distance A is then substantially equal to the second distance B.

In this example the rear end 624 of the impact absorbing means 62 is situated at a third distance C from the rigidity enhancing means 7, and an approaching product carrier 1 facing edge 4 of an approaching product carrier 1 facing longitudinal side 4 of the platform 2 is situated at a fourth distance D from the rigidity enhancing means 7. In the example of the compact product carrier 1 according to FIG. 3, the sum of the first and the third distances A, C is then substantially equal to a sum of the second and fourth distances B, D.

FIG. 4 shows a product holder 1 wherein the first distance A is smaller than the second distance B and the third distance C exceeds the fourth distance D. In that way an alternative becomes possible wherein the platform 2 of the product holder 1 can extend above a part of the obstacle, for instance when the obstacle is a leading product carrier, wherein the platform 2 of the product carrier 1, if the platform 2 of the leading product carrier is adapted for receiving the product carrier 1, can extend above the impact absorbing means 62 of a leading product carrier 1.

FIG. 5 shows a product holder 1 wherein the first distance A exceeds the second distance B and the third distance C is smaller than the fourth distance D. In that way an alternative becomes possible wherein the impact absorbing means 61 can extend below a part of the obstacle, for instance when the obstacle is a leading product carrier, wherein the impact absorbing means 61 of the product carrier 1, if the impact absorbing means 62 of the leading product carrier is adapted for receiving the product carrier 1, can extend below the platform 2 of a leading product carrier.

Summarizing it can be stated that the product carrier according to the invention is composed such that the front end 613 of the impact absorbing means 61 indeed extends slightly further away from the rigidity enhancing means 7 than the edge 3 of the tray 8 intended for the cultivation extends from the rigidity enhancing means 7, as a result of which it is prevented that the edge 3 of the tray 8 intended for the cultivation is able to bump into an obstacle.

Naturally the invention is not restricted to the preferred embodiment described and shown, but also extends to any embodiment that falls within the scope of protection as defined by the claims and considered in view of the description above and the related drawings.

1. Product holder for a rotating cultivation of crops including potted plants, which holder is provided with:
a platform that is executed predominantly flat for supporting the crops, and
running wheels and/or guide wheels that are attached to the bottom side of the platform for allowing the product holder to be rotated through a greenhouse in a manner that may or may not be automated,
wherein the platform has a largest dimension in a longitudinal direction that is oriented transverse to the driving direction of the wheels and, considered in the driving direction, is bounded by a longitudinal side,
wherein the platform comprises a self-supporting, rigidity enhancing means extending in the longitudinal direction for providing sturdiness and flatness to the platform and the entire holder, and
wherein an impact absorbing means extends from the rigidity enhancing means for absorbing force resulting from the impact the product holder is subjected to when the impact absorbing means hits an obstacle that is oriented in the driving direction.

2. Product holder according to claim 1, wherein the impact absorbing means extends to such an extent that, if the impact absorbing means hits the obstacle, an obstacle facing longitudinal side of the platform is substantially exempt from absorbing the force.

3. Product holder according to claim 2, wherein the obstacle facing side of the platform extends to such an extent that, if the impact absorbing means hits the obstacle, an obstacle facing edge of the platform almost touches the obstacle.

4. Product holder according to claim 3, wherein the obstacle facing longitudinal side of the platform is flexible.

5. Product holder according to claim 3, wherein the obstacle facing side of the platform is made of a polymer, synthetic material or rubber.

6. Product holder according to claim 1, wherein the impact absorbing means comprises a buffer element having such dimensions that a part of the obstacle hit by the impact absorbing means at least partially overlaps the buffer element.

7. Product holder according to claim 6, wherein the buffer element preferably is plate-shaped.

8. Product holder according to claim 1, wherein the impact absorbing means extends along the line of action of the force resulting from the impact that the product holder is subjected to if the impact absorbing means hits the obstacle.

9. Product holder according to claim 1,
wherein the impact absorbing means, considered in the driving direction, has a front end configured for contacting a leading product holder, and considered in the driving direction, a rear end configured for being contacted by an approaching product holder, and
wherein considered in the driving direction, the obstacle is a last product holder in a leading position relative to the trailing product holder, and
wherein the impact absorbing means of the leading product holder, extends rearwards to such an extent that, if the impact absorbing means of the leading product holder receives the product holder, a further longitudinal side of the platform of the leading product holder, which longitudinal side faces the product holder, is substantially exempt from absorbing the force.

10. Product holder according to claim 9,
wherein the front end of the impact absorbing means is situated a first distance from the rigidity enhancing means,
wherein an obstacle facing edge of an obstacle facing longitudinal side of the platform is situated at a second distance from the rigidity enhancing means, and
wherein the first distance substantially equals the second distance.

11. Product holder according to claim 9,
wherein the front end of the impact absorbing means is situated at a first distance from the rigidity enhancing means,
wherein an obstacle facing edge of an obstacle facing longitudinal side of the platform is situated at a second distance from the rigidity enhancing means,
wherein the rear end of the impact absorbing means is situated at a third distance from the rigidity enhancing means, and
wherein an approaching product holder facing edge of an approaching product holder facing longitudinal side of the platform is situated at a fourth distance from the rigidity enhancing means, and
wherein a sum of the first and the third distances is substantially equal to a sum of the second and fourth distances.

12. Product holder according to claim 11, wherein the first distance is smaller than the second distance and wherein the third distance exceeds the fourth distance.

13. Product holder according to claim 11, wherein the first distance exceeds the second distance and wherein the third distance is smaller than the fourth distance.

14. Method for rotating cultivation of crops including potted plants, using a holder that is provided with:
a platform that is executed predominantly flat for supporting the crops,
running wheels and/or guide wheels that are attached to the bottom side of the platform for enabling the holder to be rotated through a greenhouse in a manner that may or may not be automated,
wherein the platform has a largest dimension in a longitudinal direction that is oriented transverse to the driving direction of the wheels,
wherein the platform, considered in the driving direction, is bounded by a longitudinal side, and
wherein the platform comprises self-supporting, rigidity enhancing means extending in the longitudinal direction for providing sturdiness and flatness to the platform and the entire holder,
wherein an impact absorbing means extends from the rigidity enhancing means for at least almost fully absorbing force resulting from the impact the product holder is subjected to when the impact absorbing means hits an obstacle,
wherein the product holder is moved in the driving direction against the obstacle, and
wherein the obstacle, considered in the driving direction, is a last product holder in a leading position relative to a trailing product holder.

15. Method according to claim 14, wherein a further product holder is moved in the driving direction against the product holder, wherein the further product holder, considered opposite the driving direction, is a first product holder following the product holder.
